(19) United States
(12) Patent Application Publication
(10) Pub. No.: US 2005/0197457 A1
(43) Pub. Date: Sep. 8, 2005

(54) Stable organic free radical polymer systems: grafting functional monomers

(76) Inventors: Bharat I. Chaudhary, Princeton, NJ (US); Yunwa W. Cheung, Lake Jackson, TX (US); Mohamed Esseghir, Monroe Township, NJ (US); John Klier, Midland, MI (US); John D. Weaver, Lake Jackson, TX (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 11/021,955

(22) Filed: Dec. 24, 2004

Related U.S. Application Data
(60) Provisional application No. 60/532,491, filed on Dec. 24, 2003.

(51) Int. Cl. C08F 8/00

(52) U.S. Cl. 525/191

(57) ABSTRACT

The present invention is a stable organic free radical polymer system. The system is useful as a composition, provides processing advantages over existing grafting technologies, and imparts unique properties to articles of manufacture made therefrom.

### FIELD OF THE INVENTION

This invention relates to polymer systems that undergo free radical reactions in the presence of free-radical inducing species, heat, or both.

### DESCRIPTION OF THE PRIOR ART

A number of polymers can undergo free radical reactions. Some of those reactions are beneficial such as grafting while others are detrimental such as carbon-carbon crosslinking, premature crosslinking, or degrading. There is a need to promote the beneficial reactions while minimizing the impact of the detrimental reactions.

Premature crosslinking and chain scission challenge free-radical functionalization of polyolefins with organic peroxides. Notably, grafting of functional monomers to ethylene polymers is typically limited to polymers having a density of less than about 0.955 grams per cubic centimeter because (1) premature crosslinking at high process temperatures results in an undesirable increase in molecular weight and (2) uniform mixing of the functional monomers is required at low processing temperatures. At the other end of the spectrum, propylene polymers undergo chain scission in the presence of organic peroxides. Reportedly, benzoyl peroxide can mitigate chain scission; however, its use results in an undesirable molecular weight increase.

It is desirable to graft functional monomers to olefin polymers without a significant change in molecular weight. It is also desirable to apply grafting technology to ethylene polymers having a density equal to or greater than about 0.955 grams per cubic centimeter. It is further desirable to increase the processing temperature without process-limiting premature crosslinking.

### SUMMARY OF THE INVENTION

The present invention is a stable organic free radical polymer system. The system is useful as a composition, provides processing advantages over existing grafting technologies, and imparts unique properties to articles of manufacture made therefrom. As a composition, the present invention comprises (a) a free-radical reactive polymer, (b) a free-radical inducing species, (c) a stable organic free radical, and (d) a graftable monomer. As a process, the system permits alternative grafting technologies. As articles of manufacture, the system permits articles to be made having physical properties previously unachievable in view of limitations posed by previously available processes for preparing free-radical crosslinked polymers.

### DESCRIPTION OF THE INVENTION

The present invention is useful in wire-and-cable, footwear, film (e.g. greenhouse, shrink, and elastic), rheology modification, engineering thermoplastic, highly-filled, flame retardant, reactive compounding, thermoplastic elastomer, thermoplastic vulcanizate, automotive, vulcanized rubber replacement, construction, automotive, furniture, foam, wetting, adhesive, paintable substrate, dyeable polyolefin, moisture-cure, nanocomposite, compatibilizing, printing, steel replacement, wax, sizing, calendared sheet, medical, dispersion, coextrusion, cement/plastic reinforcement, food packaging, non-woven, paper-modification, multilayer container, sporting good, oriented structure, and surface treatment applications.

The present invention is a functionalizable polymeric composition comprising (i) a free-radical reactive polymer, (ii) a free-radical inducing species, (iii) a stable organic free radical, and (iv) a graftable monomer. The resulting functionalized polymer will have certain properties similar to nonfunctionalized base polymer. Those desired properties include gel content, melt index, melt index ratio (I10/I2), and modulus. Preferably, the resulting functionalized polymer with a melt index ratio reduction of less than about 30, more preferably, less about 20, and even more preferably, less than about 15. Most preferably, the melt index ratio reduction is less than about 10.

Examples of polymers useful in the present invention include hydrocarbon-based polymers. Suitable hydrocarbon-based polymers include ethylene/propylene/diene monomers, ethylene/propylene rubbers, ethylene/alpha-olefin copolymers, ethylene homopolymers, propylene homopolymers, ethylene/styrene interpolymers, ethylene/unsaturated ester copolymers, halogenated polyethylenes, propylene copolymers, natural rubber, styrene/butadiene rubber, styrene/butadiene/styrene block copolymers, styrene/ethylene/butadiene/styrene copolymers, polybutadiene rubber, butyl rubber, chloroprene rubber, chlorosulfonated polyethylene rubber, ethylene/diene copolymer, and nitrile rubber, and blends thereof.

Preferably, the polymers are olefin-based. More preferably, the polymers include polymers, which in the absence of the stable organic free radical and while in the presence of a free-radical inducing species, are susceptible to a reduction of melt index ratio (I10/I2) of greater than about 20 when processed at a temperature suitable for grafting the graftable monomer onto the polymer.

With regard to the suitable ethylene polymers, the free-radical crosslinkable polymers generally fall into four main classifications: (1) highly-branched; (2) heterogeneous linear; (3) homogeneously branched linear; and (4) homogeneously branched substantially linear. These polymers can be prepared with Ziegler-Natta catalysts, metallocene or vanadium-based single-site catalysts, or constrained geometry single-site catalysts.

Highly branched ethylene polymers include low density polyethylene (LDPE). Those polymers can be prepared with a free-radical initiator at high temperatures and high pressure. Alternatively, they can be prepared with a coordination catalyst at high temperatures and relatively low pressures. These polymers have a density between about 0.910 grams per cubic centimeter and about 0.940 grams per cubic centimeter as measured by ASTM D-792.

Heterogeneous linear ethylene polymers include linear low density polyethylene (LLDPE), ultra-low density polyethylene (ULDPE), very low density polyethylene (VLDPE), and high density polyethylene (HDPE). Linear low density ethylene polymers have a density between about 0.850 grams per cubic centimeter and about 0.940 grams per cubic centimeter and a melt index between about 0.01 to about 100 grams per 10 minutes as measured by ASTM 1238, condition I. Preferably, the melt index is between about 0.1 to about 50 grams per 10 minutes. Also, preferably, the LLDPE is an interpolymer of ethylene and one or more other alpha-olefins having from 3 to 18 carbon atoms, more preferably from 3 to 8 carbon atoms. Preferred comonomers include 1-butene, 4-methyl-1-pentene, 1-hexene, and 1-octene.

Ultra-low density polyethylene and very low density polyethylene are known interchangeably. These polymers have a density between about 0.870 grams per cubic centimeter and about 0.910 grams per cubic centimeter. High density ethylene polymers are generally homopolymers with a density between about 0.941 grams per cubic centimeter and about 0.965 grams per cubic centimeter.

Homogeneously branched linear ethylene polymers include homogeneous LLDPE. The uniformly branched/homogeneous polymers are those polymers in which the comonomer is randomly distributed within a given interpolymer molecule and wherein the interpolymer molecules have a similar ethylene/comonomer ratio within that interpolymer.

Homogeneously-branched substantially linear ethylene polymers include (a) homopolymers of C₂-C₂₀ olefins, such as ethylene, propylene, and 4-methyl-1-pentene, (b) interpolymers of ethylene with at least one C₃-C₂₀ alpha-olefin, C₂-C₂₀ acetylenically unsaturated monomer, C₄-C₁₈ diolefin, or combinations of the monomers, and (c) interpolymers of ethylene with at least one of the C₃-C₂₀ alpha-olefins, diolefins, or acetylenically unsaturated monomers in combination with other unsaturated monomers. These polymers generally have a density between about 0.850 grams per cubic centimeter and about 0.970 grams per cubic centimeter. Preferably, the density is between about 0.85 grams per cubic centimeter and about 0.955 grams per cubic centimeter, more preferably, between about 0.850 grams per cubic centimeter and 0.920 grams per cubic centimeter.

Ethylene/styrene interpolymers useful in the present invention include substantially random interpolymers prepared by polymerizing an olefin monomer (i.e., ethylene, propylene, or alpha-olefin monomer) with a vinylidene aromatic monomer, hindered aliphatic vinylidene monomer, or cycloaliphatic vinylidene monomer. Suitable olefin monomers contain from 2 to 20, preferably from 2 to 12, more preferably from 2 to 8 carbon atoms. Preferred such monomers include ethylene, propylene, 1-butene, 4-methyl-1-pentene, 1-hexene, and 1-octene. Most preferred are ethylene and a combination of ethylene with propylene or C₄₋₈ alpha-olefins. Optionally, the ethylene/styrene interpolymers polymerization components can also include ethylenically unsaturated monomers such as strained ring olefins. Examples of strained ring olefins include norbornene and C₁₋₁₀ alkyl- or C₆₋₁₀ aryl-substituted norbornenes.

Ethylene/unsaturated ester copolymers useful in the present invention can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of about 5 to about 50 percent by weight based on the weight of the copolymer, and is preferably in the range of about 15 to about 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. The melt index of the ethylene/unsaturated ester copolymers can be in the range of about 0.5 to about 50 grams per 10 minutes.

Halogenated ethylene polymers useful in the present invention include fluorinated, chlorinated, and brominated olefin polymers. The base olefin polymer can be a homopolymer or an interpolymer of olefins having from 2 to 18 carbon atoms. Preferably, the olefin polymer will be an interpolymer of ethylene with propylene or an alpha-olefin monomer having 4 to 8 carbon atoms. Preferred alpha-olefin comonomers include 1-butene, 4-methyl-1-pentene, 1-hexene, and 1-octene. Preferably, the halogenated olefin polymer is a chlorinated polyethylene.

Examples of propylene polymers useful in the present invention include propylene homopolymers and copolymers of propylene with ethylene or another unsaturated comonomer. Copolymers also include terpolymers, tetrapolymers, etc. Typically, the polypropylene copolymers comprise units derived from propylene in an amount of at least about 60 weight percent. Preferably, the propylene monomer is at least about 70 weight percent of the copolymer, more preferably at least about 80 weight percent.

Natural rubbers suitable in the present invention include high molecular weight polymers of isoprene. Preferably, the natural rubber will have a number average degree of polymerization of about 5000 and a broad molecular weight distribution.

Useful styrene/butadiene rubbers include random copolymers of styrene and butadiene. Typically, these rubbers are produced by free radical polymerization. Styrene/butadiene/styrene block copolymers of the present invention are a phase-separated system. The styrene/ethylene/butadiene/styrene copolymers useful in the present invention are prepared from the hydrogenation of styrene/butadiene/styrene copolymers.

The polybutadiene rubber useful in the present invention is preferably a homopolymer of 1,4-butadiene. Preferably, the butyl rubber of the present invention is a copolymer of isobutylene and isoprene. The isoprene is typically used in an amount between about 1.0 weight percent and about 3.0 weight percent.

For the present invention, polychloroprene rubbers are generally polymers of 2-chloro-1,3-butadine. Preferably, the rubber is produced by an emulsion polymerization. Additionally, the polymerization can occur in the presence of sulfur to incorporate crosslinking in the polymer.

Preferably, the nitrile rubber of the present invention is a random copolymer of butadiene and acrylonitrile.

Other useful free-radical crosslinkable polymers include silicone rubbers and fluorocarbon rubbers. Silicone rubbers include rubbers with a siloxane backbone of the form —Si—O—Si—O—. Fluorocarbon rubbers useful in the present invention include copolymers or terpolymers of vinylidene fluoride, hexafluoropropylene, and tetrafluoroethylene with a cure site monomer to permit free-radical crosslinking.

Useful free-radical inducing species include organic peroxides, Azo free radical initiators, and bicumene. Preferably, the free-radical inducing species is an organic peroxide. Also, oxygen-rich environments can initiate useful free-radicals. Preferable organic peroxides include dicumyl peroxide and Vulcup R. The organic peroxide can be added via direct injection. Preferably, the free-radical inducing species is present in an amount between about 0.5 weight percent and about 5.0 weight percent, more preferably, between about 0.5 weight percent and about 2.0 weight percent.

The stable organic free radicals useful in the present invention include (i) hindered amine-derived stable organic free radicals, (ii) iniferters, (iii) organometallic compounds, and (iv) aryl azooxy radical. Preferably, the stable organic free radical is a hindered amine-derived stable organic free radical selected from the group consisting of 2,2,6,6,-tetramethyl piperidinyl oxy (TEMPO) and its derivatives. More preferably, the stable organic free radical is bis-TEMPO, oxo-TEMPO, hydroxy-TEMPO, an ester of hydroxy-TEMPO, polymer-bound TEMPO, PROXYL, DOXYL, di-tertiary butyl N oxyl, dimethyl diphenylpyrrolidine-1-oxyl, 4 phosphonoxy TEMPO, or a metal complex with TEMPO. Even more preferably, the stable organic free radical is bis-TEMPO or hydroxy-TEMPO.

Iniferters are compounds capable of initiating and terminating free radical reactions. They are also capable of reversibly terminating growing polymer chains. When the stable organic free radical is an iniferter, it is preferably selected from the group consisting of tetraethyl thiuram disulfide, benzyl NN diethyldithiocarbamate, dithiocarbamate, polythiocarbamate, and S benzyl dithiocarbamate.

The stable organic free radical and free-radical inducing species can be combined with the free-radical crosslinkable polymer in a variety of ways, including direct compounding, direct soaking, and direct injection.

Examples of useful graftable monomers are maleic anhydride and silanes. The resulting grafting level is preferably greater than about 0.5 weight percent monomer. More preferably, the grafting level is greater than about 1.0 weight percent monomer. Most preferably, the grafting level is greater than about 1.5 weight percent monomer.

Other additives are useful with the present invention. Those additives include scorch inhibitors, antioxidants, fillers, clays, processing aids, carbon black, flame retardants, peroxides, other polymers, and colorants. The crosslinkable polymeric compositions can be highly filled or semiconductive.

In another embodiment, the present invention is a process for preparing a functionalized polymer comprising the steps of (a) preparing a polymer-matrix mixture by admixing and heating (i) a polymer being capable of forming free radicals when induced by a free-radical inducing species, (ii) a free-radical inducing species, (iii) a stable organic free radical, and (iv) a graftable monomer and (b) grafting the graftable monomer onto the polymer to form a functionalized polymer, wherein the stable organic free radical substantially prevents crosslinking of the polymer during Step (a), thereby preferentially promoting the grafting of the graftable monomer onto the polymer in Step (b). Preferably, the mixing step renders the free-radical inducing species and the graftable monomer uniformly distributed in the polymer-matrix mixture.

The process may be continuous or batch. As a continuous process, the process will preferably have a residence time in an extruder of less than about 60 seconds. More preferably, the residence time will be less than about 35 seconds.

In yet another embodiment, the present invention is a process for preparing a functionalized polymer comprising the steps of (a) preparing a polymer-matrix mixture by admixing and heating (i) a polymer being capable of forming free radicals when induced by a free-radical inducing species, (ii) a free-radical inducing species, (iii) a stable organic free radical, and (iv) a graftable monomer and (b) grafting the graftable monomer onto the polymer to form a functionalized polymer, wherein the stable organic free radical substantially prevents chain scission of the polymer during Step (a), thereby preferentially promoting the grafting of the graftable monomer onto the polymer in Step (b). Preferably, the free-radical inducing species is present in amount between about 0.02 weight percent and about 0.08 weight percent, the stable organic free radical is present in amount between about 0.03 weight percent and about 0.10 weight percent, and the graftable monomer is present in amount between about 0.10 weight percent and about 5.0 weight percent. This invention also includes articles of manufacture made from the functionalized polymer.

In yet another embodiment, the present invention is a process for preparing a functionalized polymer comprising the steps of (a) forming a polymer-matrix mixture by mixing and heating (i) a base polymer being capable of forming free radicals in the presence of a free-radical inducing species, (ii) a free-radical-inducing species, and (iii) a stable organic free radical, and (b) grafting the stable organic free radical onto the base polymer to form a functionalized polymer. This embodiment includes articles of manufacture made from the functionalized polymer and processes that use the resulting functionalized polymer. Preferably, the polymer will be substantially free of chain scission during the process.

1. A functionalizable polymeric composition comprising:
(a) a free-radical reactive polymer,
(b) a free-radical inducing species, and
(c) a stable organic free radical, and
(d) a graftable monomer.
